(19) United States
(12) Patent Application Publication
(10) Pub. No.: US 2005/0280272 A1
(43) Pub. Date: Dec. 22, 2005

(54) Articulating vehicle trailer

(76) Inventors: Kenneth Lawrance Vokey, Banie (CA); Kenneth Alberto Vokey, Banie (CA)

Correspondence Address: Kenneth Lawrence Vokey, 4754 County Road 90, R.R.2, Barrie, ON, L4M 4S4, CA

(21) Appl. No.: 10/872,000

(22) Filed: Jun. 21, 2004

(51) Int. Cl. B62D 33/02

(52) U.S. Cl. 296/25

(57) ABSTRACT

A vehicle trailer with a frame independently suspended on a pair of wheels and an articulating bed movable between a raised transport position and a lowered loading position.

### BACKGROUD

1. Field of the Invention

The present invention relates to vehicle trailers and more particularly to a trailer having an articulating bed and independent wheel suspension.

2. Description of the Prior Art

Trailers have long been used behind various sorts of vehicles such as cars or trucks in order to increase the load carrying capacity of such vehicles. To date the majority of such trailers have provided a single frame structure which is supported on a plurality of wheels connected with at least 1 common axle. Efforts to make such trailers more useful while remaining economical of manufacture have resulted in tilting mechanisms where the trailer box or bed is rotated about a axis adjacent said support wheels and said common axle. This results in a high angle of entry and corresponding difficulty and expense in its use. Of particular note is the requirement to restrain movement of the bed while loading, unloading and in transport. Other efforts have been directed at mechanisms to lower the trailer as a whole towards the ground. Typically these results have been problematic in use and expensive and troublesome to build and maintain.

The present invention seeks to overcome these problems and provide a novel vehicle trailer which is economical to manufacture and simple to use and maintain.

It is a further object of the invention to provide a vehicle trailer which is robust in design and safe in both loading and transport.

### SUMMARY OF THE INVENTION

The invention provides an articulating vehicle trailer comprising a frame supported on at least a pair of wheels independently suspended from said frame, means to removable attach said frame to a vehicle, an articulating trailer bed supported on said frame, and wherein said articulating bed is adapted to be raised within said frame to a transport position and lowered below said frame to a loading position. The frame comprises a forward generally transverse member and a longitudinal member to each side of said trailer bed and preferably includes a removable rear generally transverse member.

The articulating trailer bed is hinged adjacent said forward transverse member for movement between a generally horizontal transport position and a rearwardly sloped loading position. Alternatively, the trailer bed is articulated vertically by a cable or threaded rod combination for movement generally parallel to the ground. Further, the bed may be articulated to said frame by a parallelogram linkage including a pair of rotating parallel arms on each side of said trailer bed.

The invention also provides, in another aspect, a vehicle trailer ski attachment comprising ski means, spaced apart lateral wheel retention means, restraining strap means secured to a forward end of said ski means and adapted to be secured to a rearward end of said ski means.

### DESCRIPTION OF THE DRAWINGS

FIG. 1 is a side elevation of the covered trailer of a typical prior art covered trailer including side windows and carrying racks.

FIG. 2 is a front elevation of the trailer of FIG. 1.

FIG. 3 is a rear elevation of the trailer of FIG. 1 showing the trailer floor with the rear access door of the invention in the elevated position.

FIG. 4 is a side elevation of the ski runner attachment of the invention installed on the trailer wheel.

FIG. 5 is a frontal elevation of the ski attachment of FIG. 4.

FIGS. 6a and 6b are plan views of the ski attachment of FIGS. 4 and 5 without (FIG. 6a) and with (FIG. 6b) the installed wheel respectively.

FIG. 7 is a plan view of the tilt-bed embodiment of the trailer bed of the invention shown in FIGS. 1 through 3 shown in the elevated transport position as in FIG. 3.

FIG. 8 is a rear elevation of the tilt-bed embodiment of FIG. 7 in the loading position.

FIG. 9 is a side elevation of the articulating-bed embodiment of the invention.

FIG. 10 is a side elevation of the raised-flat embodiment of the invention.

FIG. 11 is a side elevation of the leaf spring wheel suspension.

FIG. 12 is a side elevation of the suspension of FIG. 11 in another embodiment.

FIG. 13 is a side elevation of a further alternative embodiment of the trailer of FIG. 10.

### DETAILED DESCRIPTION OF THE INVENTION AND THE PREFERRED EMBODIMENTS

Throughout the drawings similar numerals refer to the same or corresponding components.

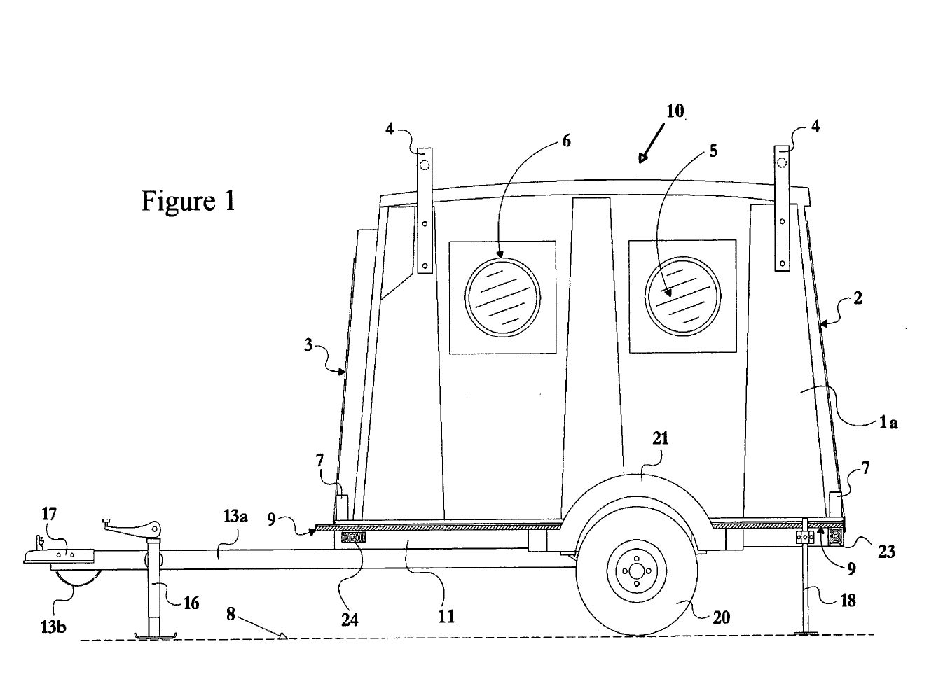

A covered utility trailer 10 of the prior art is shown in side elevation in FIG. 1. Trailer 10 includes a hitch 17 by which main frame 13a may be towed by a towing vehicle (not shown) and an enclosure 1a. Main frame 13a is supported above nominal ground level 8 on a pair of wheels 20 with optional supports by frame support 13b, jack 16 and leg supports 18 in a known fashion. Wheels 20 are each provided with fenders 21.

Enclosure 1a may include top supports as at 4 and bottom supports as at 7 for external carriage of extra items such as small boats and the like as well as side windows 5 and 6 and safety lights 23 and 24.

Enclosure 1a may be formed of a single extruded plastic shell secured to a floor panel 9 which in turn is supported by a metal sub-frame 11. Sub-frame 11 is secured to main frame 13a in a known fashion and extends rearward of wheels 20.

Enclosure 1a is fitted with front and rear access doors as at 3 and 2 respectively in FIG. 1.

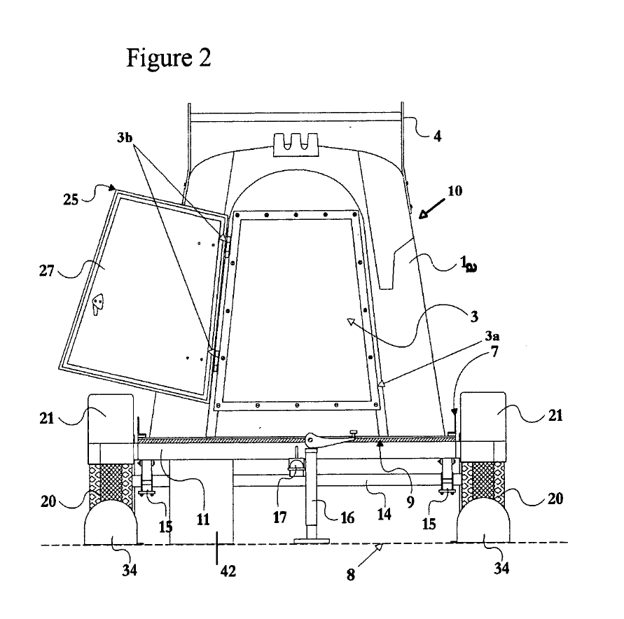

FIG. 2 is a front elevation of the trailer of FIG. 1. Front access door 3 is shown in the open position and includes a stationary full frame 3a, a pair of hinges 3b and a door panel 27 supported by door frame 25.

Each of wheels 20 in FIG. 2 are shown with ski runner attachments 34 of the invention and an ice-fishing tubular collar 42.

Details of a typical trailer prior art suspension can be seen in FIG. 2 and include a continuous axel 14 and leaf springs 15.

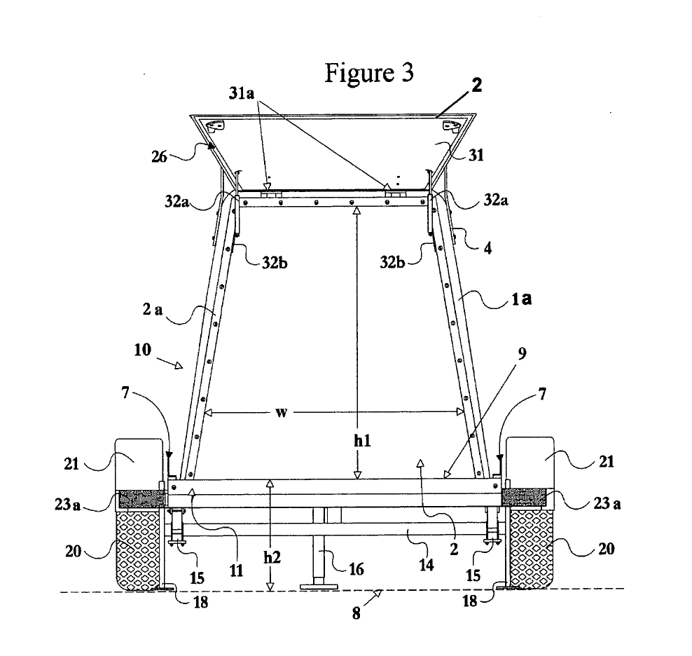

FIG. 3 is a rear elevation of the trailer of FIG. 1 as at 10 showing the rear access door 2 of the preferred embodiment of the invention in the fully open position.

In FIG. 3 enclosure 1a is fitted with a 3-sided door frame 2a. The enclosure 1a is supported at the rear of the trailer by attachment of floor 9 (not shown in FIG. 3) and sub-frame 11 for ease of entry.

Preferably rear access door 2 includes an upwardly foldable door panel 31 with a rear door frame 26 hinged about a horizontal axis as at hinges 31a.

Door panel 31 is preferably supported in the open position by a pair of hydraulic cylinders 32a attached between door panel 31 or frame 26 (not shown) and frame 2a as at 32b.

Rear traffic warning lights 23a may be attached to frame 11 or fender 21.

Rear access door 2 provides for trailer access within height ‘h1’ between floor at 9 and frame 2a and a variable width ‘w’ as shown in FIG. 3.

Floor 9 is in an elevated position, a height of ‘h2’ above nominal ground level 8.

As may be seen trailer floor 9 being at a fixed height ‘h2’ above nominal ground level 8 as in the prior art makes entry to enclosure 1a awkward for both persons and equipment and limits the access door 2 height to ‘h1’.

FIG. 4 is a side elevation of the ski runner attachment 10a of the invention as secured to a trailer wheel 20 for support of trailer 10 as shown in FIGS. 1 through 3. Ski runner blade 34 may be fabricated from mild steel or various plastic materials and preferably includes a stiffening frame 35 which may be adapted to fully support runner blade 34 as may be required for plastic materials. Frame 35 also provides support for upstanding vertical restraint panels 36a and 36b, being starboard and port side panels.

As shown in FIGS. 4, 5 and 6 restraint panels 36 are spaced apart so as to accommodate wheel 20 and preferably provide a partial enclosure for wheel 20 as shown in FIG. 4.

Rods 37b and 37a extend between the restraint panels 36 at the forward and rear extent of said panels and are secured in place. Rod 37a may be removable as with easy release fasteners not shown to accommodate easy entry of wheel 20 into the enclosure from the rear.

Strap 33 extends from front rod 37b around wheel 20 and around rod 37a and then to the rear of the ski runner as in FIG. 4. At the time of installation, rear rod 37a may be inserted after the strap 33 is positioned for ease of assembly. Strap 33 is provided with a terminal loop as at 38 in FIG. 4 which engages a locking and tightening clamp 39 which itself is affixed to the rear of ski runner 34 as at 40 in a conventional manner.

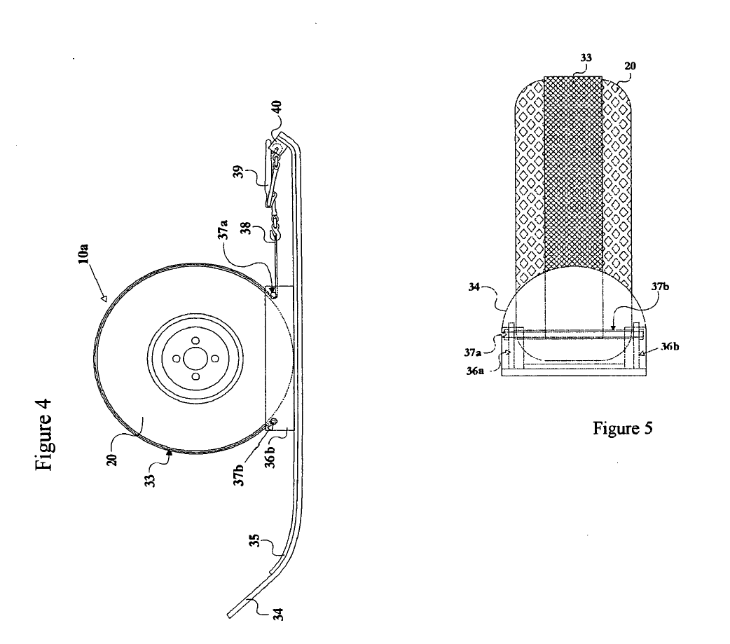

As shown in FIG. 5 strap 33 is preferably a substantial portion of the width of the wheel and may extend completely across the space between panels 36. Upon tightening of clamp 39 strap 33 frictionally engages wheel 20 and compresses it downwards and into engagement with ski runner 34, frame 35 and panels 36 providing a robust assembly.

FIG. 5 shows a frontal elevation of the wheel 20 and runner 34 assembly of FIG. 4 with strap 33 shown as a substantial width for ease of illustration.

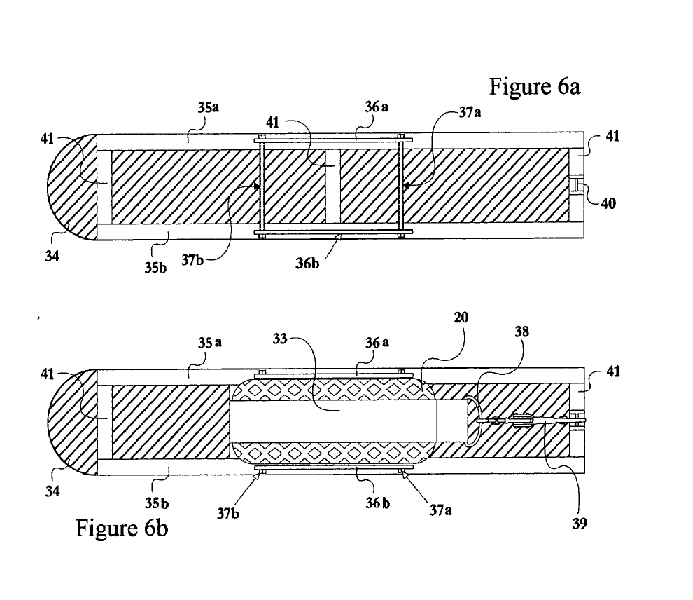

FIG. 6 provides a top view of ski runner 34 both without, FIG. 6a, and with, FIG. 6b, a wheel 20 secured in place in accordance with the invention, respectively. Frame 35 is preferably a pair of elements 35a and 35b extending along the lateral edges of ski runner blade 34 and completed by a trio of lateral frame elements 41, the rearmost of which may accommodate attachment 40.

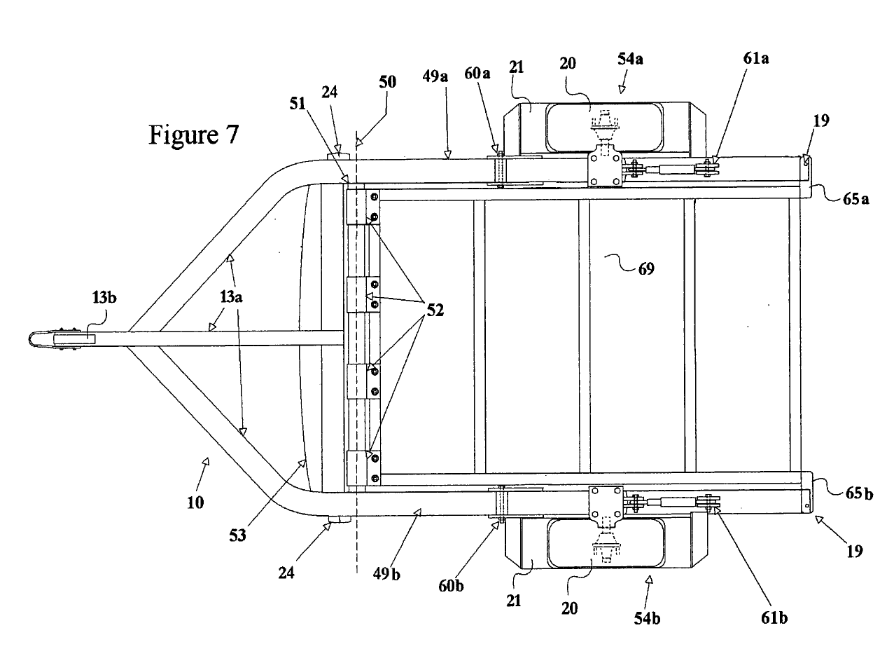

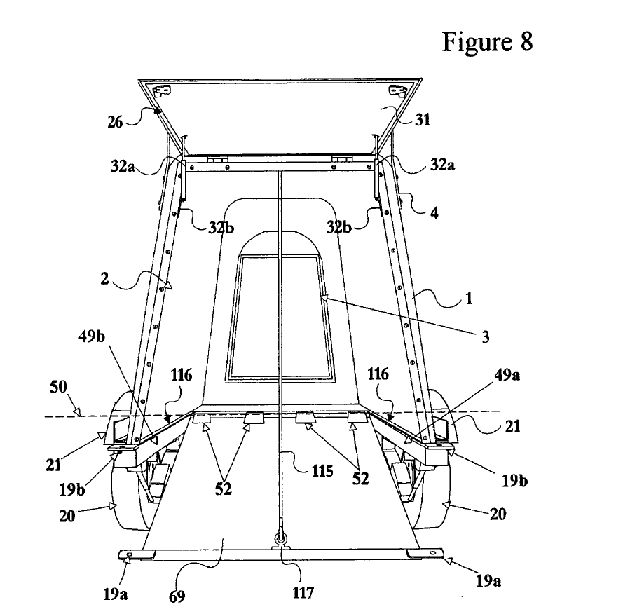

FIG. 7 is a plan view of the preferred embodiment of the trailer 10 of the invention. Main frame 13a as shown in FIG. 1 is depicted in FIG. 7 in a typical fashion with 3 components 13a (FIG. 7) and a transverse structural element 53. Floor 69 of the trailer 10 is articulated at its forward end for rotation about transverse axis 50, preferably by rotation of hinge elements 52 about axle 51 between a raised transport position as in FIG. 7 and a lowered loading position as in FIG. 8.

Frame 13a includes starboard longitudinal frame element 49a and port side frame element 49b extend rearwards of wheel 20 and preferably to the rear of the trailer 10. Frame elements 49 are preferably part of frame 13 but may be configured as part of sub-frame 11 as shown in FIGS. 1, 2 and 3.

Side frame elements 49 extend on each side of floor 69 and support the enclosure 1, wheel assemblies 54 and floor supports 65.

In the raised transport position of FIG. 7 supports 65a and 65b are pinned to corresponding frame elements 49 as at 19.

Wheel assemblies 54a and 54b are attached to corresponding frame elements 49 as at forward attachments 60a and 60b and rearward attachments 61a and 61b respectively. No common axle is provided as the wheel assemblies provide an independent suspension.

In FIG. 8 the preferred embodiment of FIG. 7 is shown in rear elevation with the floor 69 in its lowered loading position having hinged downward at its forward end about axis 50 by hinge elements 52.

Side frame elements 49 provide support for enclosure 1 as at 116 along each side of floor 69 independent of the floor position. Floor 69 is raised and lowered by cable mechanism 117 which is detachably affixed to floor 69. Once raised by cable 117 floor extensions as at 19a and 19b respectively are brought into contact with frame 49 as at 19b to be fixed together as by pinning at 19 or other suitable means, not shown.

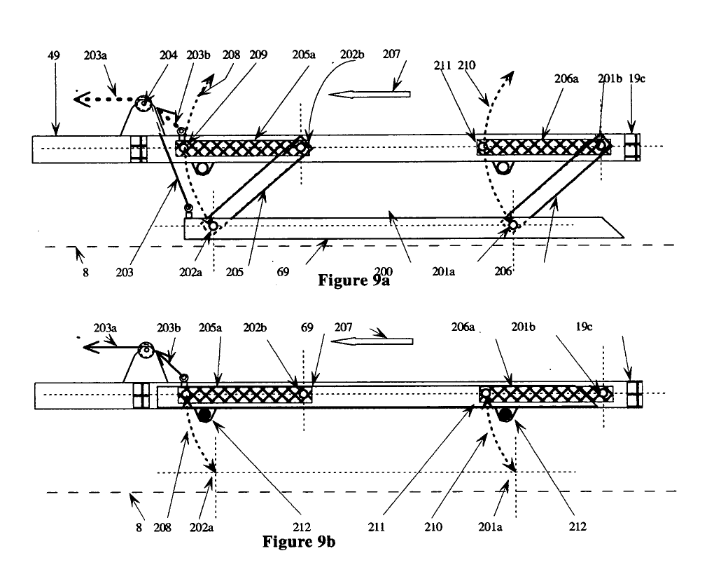

Another embodiment of the trailer 10 of the invention is shown in FIGS. 9a and 9b where articulating floor 69 is suspended from frame elements 49 by a parallelogram linkage 200 for trailing motion over the ground as in direction 207. Linkage 200 includes forward link element 205 and rear link element 206 and preferably articulates forward in the direction of travel 207 to a raised transport position as at 205a and 206a. Link element 205 is rotatably attached to frame 49 along upper and lower transverse axes 202b and 202a respectively from rotation between lowered position as at axis 202a along curve 208 to raised position as at 209. Correspondingly link element 206 is rotatably attached to frame 49 adjacent is rear extremity along upper and lower transverse axes 201b and 201a for rotation between lowered position as at axis 201a along curve 210 to raised position 211. In FIG. 9a floor 69 is shown in a lowered position which may be at or near the level of the ground 8.

Raising and lowering of floor 69 in FIG. 9 is preferably provided by adjusting the length of link or cable 203, extending between floor 69 and attachment point 204 on frame 49, from a lowered rearward position as shown in FIG. 9a and an upward and raised position as at 205a and 206a as shown in FIG. 9b. Cable or link 203 is shortened along path 203 to its upper or raised position as at 203a and 203b in FIG. 9.

In the upward position of FIG. 9b floor 69 can be affixed in position within frame 49 for safety as at 19c which is preferably a transverse bar or clamped as at 19a and 19b as shown in FIG. 8.

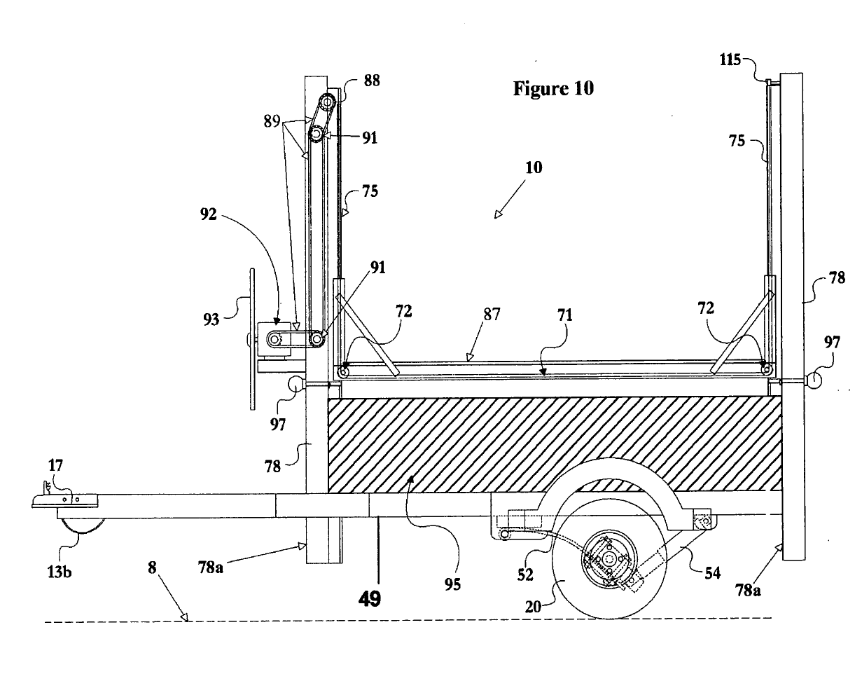

FIG. 10 shows a further embodiment of the articulating trailer of the invention 10. Front and rear vertical stanchions 78 extend upwards from frame 49 on either side of floor 87 and downwards as at 78a. Floor 87 is suspended on a pair of cable links 75 secured between rear attachment 115 and front winder 88. Each cable link 75 runs under floor 87 as at 71 and about pulleys 72. Lengthening cable link 75 as by winder at 88 lowers the floor 87 to any desired height from a loading position adjacent the ground 8 to the raised position shown in FIG. 10 where it may be mechanically secured as by pins 97.

Preferably stanchions 78 provide guide tracks (not shown) for vertical motion of floor 87 without significant lateral movement.

The winder at 88 is operated by wheel 93 attached to transmission 92 and turns winder 88 through a series of chain loops 89 and gears 91.

Side walls of trailer 10 may be closed as by panels 95.

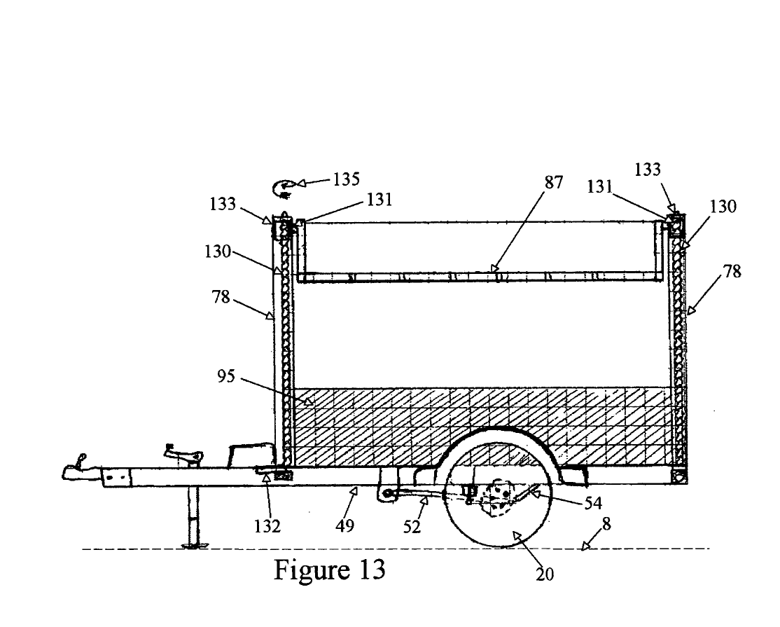

A further embodiment of the trailer of FIG. 10 is shown in FIG. 13 where elevation/retraction is provided by 4 threaded rods 130 and cooperating and captive nuts 131 (known in the trade as Acme threaded rod) one mounted at each corner of floor 87 as at 133. Preferably each rod 130 is mounted for vertical axis rotation as at 133 in a known fashion. Further alternately, each rod may be inclined (not shown). Rotation in unison as by motor and gear mechanism 132 and at the same rate 135 will cause vertical motion of each of the captive nuts 131 associated with floor 87 and raise or lower the floor 87 as required. Alternatively, the rods 130 may be driven separately or in pairs or at non-uniform rates to provide for variable rate or non-level adjustment of the floor 87. Rotation of rods 130 may be by cable, chain or shaft and gear combination (not shown).

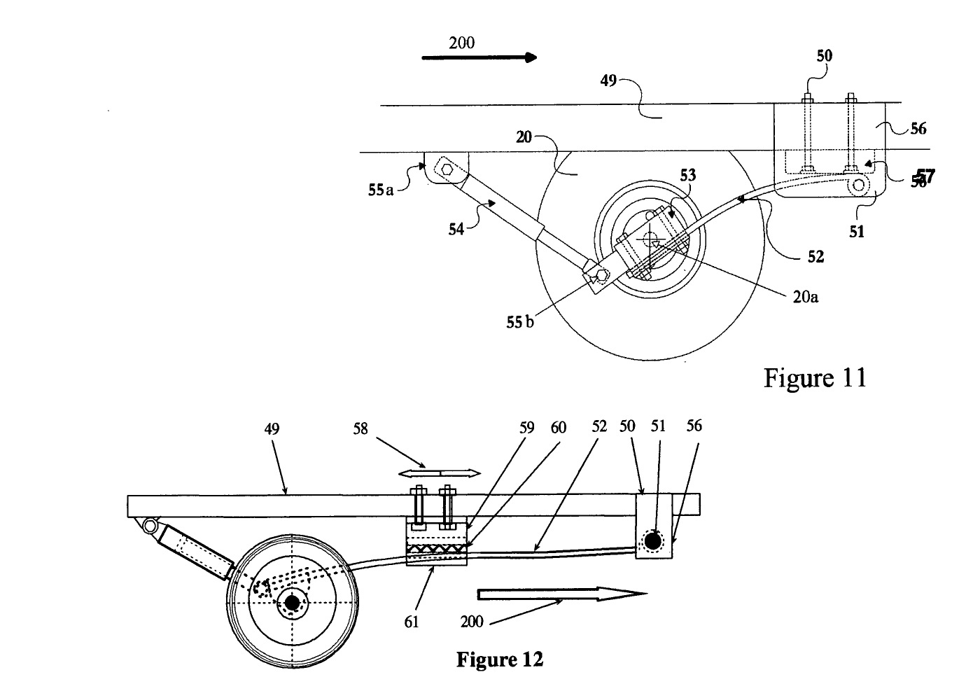

FIG. 11 depicts the preferred embodiment of the wheel support of the invention shown in relation to the direction of forward trailer travel 200. Wheel 20 is mounted for axial rotation about axis 20a provided within mounting block 53 which is secured to forward leaf spring 52. Leaf spring 52 is pivotally attached, as at 51, to and between bearing plates 56 secured to either side of frame 49 as at 50 for abutment against stop 56 when in use.

The rearward end of leaf spring 52 is restrained by shock absorber 54 secured at 55a to frame 49 and 55b to leaf spring 52.

In FIG. 12 is shown an alternative embodiment of the wheel support shown in FIG. 11. Stop 60 is associated with movable restraint 59 between bearing plates 61 to further laterally restrain leaf spring 52. Restraint 59 may be moved forwardly or rearwardly as at 58 to provide for variable vertical motion in leaf spring 52 while providing a high degree of lateral support particularly useful in heavy load or uneven terrain situations.

Many changes and modifications in the above described embodiment of the invention can be carried out without departing from the scope thereof.

1) An articulating vehicle trailer comprising:
i) a frame supported on at least a pair of wheels independently suspended from said frame,
ii) means to removable attach said frame to a vehicle,
iii) an articulating trailer bed supported on said frame, and
iv) said articulating bed adapted to be raised within said frame to a transport position and lowered below said frame to a loading position.

2) An articulating trailer as claimed in claim 1 wherein said frame comprises a forward generally transverse member and a longitudinal member to each side of said trailer bed.

3) An articulating trailer as claimed in claim 2 wherein said frame further includes a removable rear generally transverse member.

4) An articulating trailer as claimed in claims 1, 2 or 3 wherein said articulating trailer bed is hinged adjacent said forward transverse member for movement between a generally horizontal transport position and a rearwardly sloped loading position.

5) An articulating trailer as claimed in claims 1, 2 or 3 wherein said trailer bed is articulated vertically by a cable or threaded rod combination for movement generally parallel to the ground.

6) An articulating trailer as claimed in claims 1, 2 or 3 wherein said trailer bed is articulated to said frame by a parallelogram linkage.

7) An articulating trailer as claimed in claim 6 wherein said linkage includes a pair of rotating parallel arms on each side of said trailer bed.

8) An independent trailer suspension comprising:
a) a trailer frame,
b) a mount for a trailer wheel and tire combination,
c) leaf spring means mounted to said trailer and said mount and adapted to permit vertical movement of said wheel and tire combination,
d) shock absorber means, and
e) means to limit vertical and horizontal motion of said leaf spring means and said mount means.

9) A vehicle trailer ski attachment comprising:
a) Ski means,
b) Spaced apart lateral wheel retention means
c) Restraining strap means secured to a forward end of said ski means and adapted to be secured to a rearward end of said ski means.
